(19) United States
(12) Patent Application Publication
(10) Pub. No.: US 2021/0334398 A1
(43) Pub. Date: Oct. 28, 2021

(54) TRAVEL DISTANCE INDICATION DEVICE AND METHOD

(71) Applicant: LG ELECTRONICS INC., Seoul (KR)

(72) Inventors: Jaeyong LEE, Seoul (KR); Younki KU, Seoul (KR)

(73) Assignee: LG ELECTRONICS INC., Seoul (KR)

(21) Appl. No.: 16/486,130

(22) PCT Filed: Apr. 17, 2019
(86) PCT No.: PCT/KR2019/004639

§ 371 Date: Aug. 14, 2019

Related U.S. Application Data
(60) Provisional application No. 62/831,728, filed on Apr. 10, 2019.

(51) Int. Cl. G06F 21/62; G06F 3/147; G07C 5/06

(52) U.S. Cl. CPC G06F 21/6218; G07C 5/06; G06F 3/147

(57) ABSTRACT

Provided is a travel distance indication device including a controller, wherein the controller includes: storage including a first memory for storing a cumulative travel distance and a second memory for storing a cumulative travel distance encoded value; a processing unit including a trusted processor for verifying whether the cumulative travel distance is valid, based on the cumulative travel distance encoded value; a display for displaying the cumulative travel distance when the cumulative travel distance is valid, wherein the storage and the display are accessible only by the trusted processor.

### TECHNICAL FIELD

The present disclosure relates to a vehicle travel distance indication device and method, and, more particularly, to a vehicle travel distance indication device and method for preventing forgery or tampering of an accumulated travel distance, in which a travel distance-related operation is executed only by a trusted processor, and multiple security-specific memories are used.

### BACKGROUND ART

In a vehicle, a cluster device is a vehicle instrument panel that displays the accumulated travel distance of the vehicle, a speedometer, a coolant thermometer, and an engine revolving meter. An analog cluster device displays a numerical value for each item using a needle and scale. A digital cluster device displays the numerical value for each item electronically.

Conventionally, there have been many attempts to protect a travel distance measurement sensor in order to prevent tampering of the cumulative travel distance. However, there is insufficient protection against the cumulative travel distance tampering using software manipulation in the cluster device. It is easier to tamper the travel distance indication in the cluster device than to tamper the travel distance measurement sensor. Therefore, devices and methods are needed to prevent falsification or tampering of the travel distance indication.

### DISCLOSURE

### Technical Purposes

A purpose of the present disclosure is to solve the above-mentioned problems and other problems. A purpose of the present disclosure is to provide a device and method for protecting a cumulative travel distance indication device of a vehicle.

### Technical Solutions

In one aspect of the present disclosure, there is provided a travel distance indication device including a controller, wherein the controller includes: a storage including a first memory for storing a cumulative travel distance and a second memory for storing a cumulative travel distance encoded value; a processing unit including a trusted processor for verifying whether the cumulative travel distance is valid, based on the cumulative travel distance encoded value; and a display for displaying the cumulative travel distance when the cumulative travel distance is valid, wherein the storage and the display are accessible only by the trusted processor.

In one implementation of the travel distance indication device, the first memory is a non-volatile memory, and the second memory is a memory in which data is not modified.

In one implementation of the travel distance indication device, the cumulative travel distance encoded value is a total amount of data input to the second memory and is different from the cumulative travel distance, wherein the trusted processor further inputs data into the second memory every time a vehicle moves by a predetermined travel distance.

In one implementation of the travel distance indication device, verifying whether the cumulative travel distance is valid includes: dividing the cumulative travel distance by the predetermined travel distance to obtain a dividing result; and comparing the dividing result with the cumulative travel distance encoded value.

In one implementation of the travel distance indication device, the storage further comprises a third memory as a volatile memory, wherein the third memory is accessible only by the trusted processor, wherein the third memory is used to add an measured value from a travel distance measurement sensor to the cumulative travel distance.

In one implementation of the travel distance indication device, the measured value from the travel distance measurement sensor is encrypted and transmitted to the trusted processor.

In one implementation of the travel distance indication device, the display includes a display control unit and a display unit, wherein the display control unit is accessible only by the trusted processor, wherein the display unit displays the cumulative travel distance under control of the display control unit.

In one implementation of the travel distance indication device, the processing unit further includes a general processor, wherein the general processor and the trusted processor are separate from each other, wherein the general processor performs an operation other than a travel distance related operation.

In one implementation of the travel distance indication device, the trusted processor controls the display to display an error when the cumulative travel distance is invalid.

### Technical Effect

According to one embodiment of the present disclosure, the cumulative travel distance indication device of the vehicle is protected so that the cumulative travel distance of the vehicle cannot be forged or tampered.

### BRIEF DESCRIPTION OF THE DRAWINGS

FIG. 1 shows a travel distance indication device including a general processor and a trusted processor according to one embodiment of the present disclosure.

FIG. 2 shows components of a travel distance indication device according to one embodiment of the present disclosure.

FIG. 3 shows a flow diagram of a travel distance indication method according to one embodiment of the present disclosure.

### DETAILED DESCRIPTIONS

Examples of various embodiments are illustrated and described further below. The same reference numbers in different figures denote the same or similar elements, and as such perform similar functionality. Further, descriptions and details of well-known steps and elements are omitted for simplicity of the description. Suffixes “module” and “unit” for components used in the following description are to be given or mixed with other only in consideration of ease of drafting of the present disclosure, and may have the same meaning or role by itself. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure. Further, the accompanying drawings are included to provide easy understanding of the embodiments disclosed herein. The technical idea or scope as disclosed in the present specification is not limited to the attached drawings. It will be understood that the description herein is not intended to limit the claims to the specific embodiments described. On the contrary, it is intended to cover alternatives, modifications, and equivalents as may be included within the spirit and scope of the present disclosure as defined by the appended claims.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section.

It will be understood that when an element or layer is referred to as being “connected to”, or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

As used herein, the singular forms “a” and “an” are intended to include the plural forms as well, unless the context clearly indicates otherwise.

It will be further understood that the terms “comprises”, “comprising”, “includes”, and “including” when used in this specification, specify the presence of the stated features, integers, operations, elements, and/or components, but do not preclude the presence or addition of one or more other features, integers, operations, elements, components, and/or portions thereof.

Herein, the travel distance indication device is the same as the digital cluster. Thus, only the travel distance indication related function thereof will be described.

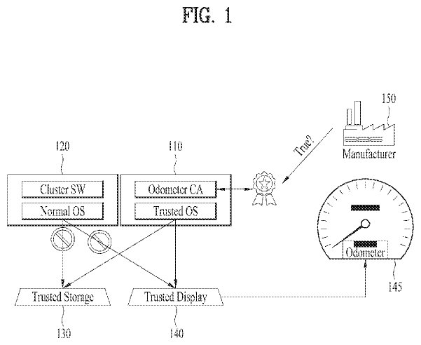

FIG. 1 shows a travel distance indication device including a general processor and a trusted processor according to one embodiment of the present disclosure.

In addition to the travel distance, the digital cluster device may calculate and display various values about a speedometer, a coolant thermometer, ab engine revolving meter, and so on. Therefore, the general processor 120 processes data items other than the travel distance. However, the trusted processor 110 processes the travel distance to prevent forgery or tampering thereof.

The trusted processor 110 reads a cumulative travel distance related data from a storage 130 and displays the data on a trusted interface 145 of a display 140. The general processor 120 cannot be connected to the storage 140 and the display 140. Only the trusted processor 120 may be connected thereto.

The trusted processor 110 and the general processor 120 are separate processors and operate on separate operating systems. The trusted processor 110 may have a program code and data embedded therein and thus cannot be accessed from an outside. Therefore, it is impossible for the general processor 120 to access the trusted processor 110.

Considering a case of replacing an entirety of a digital cluster or travel distance indication device, the present approach may check the forgery or tampering by comparing a cumulative travel distance recorded in a manufacturer 150 or external storage with a cumulative travel distance recorded in the digital cluster.

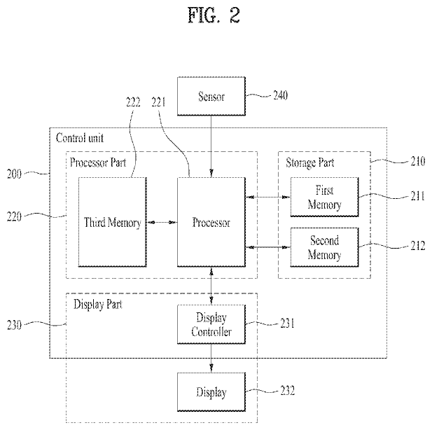

FIG. 2 shows components of a travel distance indication device according to one embodiment of the present disclosure. However, details of the general processor 120 are omitted in order to focus on the travel distance related item.

The travel distance indication device includes a controller 200. The controller 200 includes a storage 210, a controller 220, and a display 230. The controller 200 is connected to a travel distance measuring sensor 240.

The storage 210 includes a first memory 211 and a second memory 212.

The first memory 211 stores the latest value of the travel distance updated using data from the travel distance measuring sensor 240. The first memory 211 is a nonvolatile memory. Even when power is not supplied, stored data is not lost or changed in the first memory 211. Further, the first memory 211 is specialized for security. Thus, it is impossible to tamper the first memory 211 from the outside without accessing the trusted processor 211.

The second memory 212 is configured for supplementing the first memory 211. The second memory 212 has the highest security since when a bit of the memory becomes 1 in hardware manner, the memory cannot change back the bit 1 to a bit 0. For example, an example of the second memory 212 may include a device such as eFuse or Replay Protected Memory Block (RPMB). The second memory is generally used for important key and downgrade protection. The second memory 212 may be subjected to read/write operations only via accessing the trusted processor 221. Once the data has entered the second memory, modification of the data therein is not possible in any way. However, the device that cannot be reprogrammed in this way is expensive compared to other type memories Thus, it is not desirable to employ the second memory having a large capacity.

Therefore, the first memory 211 stores the cumulative travel distance. The second memory 212 stores a cumulative travel distance encoded value to verify the cumulative travel distance. The cumulative travel distance encoded value refers to a sum of bits set to 1 in the second memory 212. Each time the vehicle travel distance exceeds a predetermined travel distance, the second memory 212 sets a bit not yet used to 1. For example, it may be assumed that a bit of the second memory 212 is set to 1 every time the vehicle travels by 1000 Km. In this case, when the cumulative travel distance is 6300 km, the second memory 212 will have a total of six bits set to 1. Therefore, the cumulative travel distance encoded value is 6. In this situation, when the cumulative travel distance is tampered down to 5300 km, the cumulative travel distance is smaller than 6000 km equal to the multiplication of the predetermined travel distance 1000 km by the encoded value 6. Thus, the forgery or tampering can be checked immediately. Conversely, the forgery or tampering can be verified by comparing a value resulting from dividing the cumulative travel distance by the predetermined travel distance with the cumulative travel distance encoded value. In this example, the predetermined travel distance is set to 1000 Km. However, the predetermined travel distance may vary depending on the situation.

A processing unit 220 includes a trusted processor 221 and a third memory 222.

The trusted processor 221 is a security-specific processor. It may be difficult to access and manipulate the trusted processor 221 from the outside. For example, a processor with TrustZone technology developed by the ARM corporation may be the trusted processor 221.

The third memory 222 is a volatile memory. When the power is turned off, the stored data therein disappears. The third memory 222 performs an operation of summing the measured value from the travel distance measurement sensor 240 and the cumulative travel distance stored in the first memory 211. The third memory 222 is accessible only by the trusted processor 221. An access thereto from the outside is impossible. For this purpose, the third memory may be embedded in a chip or an encrypted memory may be used as the third memory.

The travel distance measurement sensor 240 may be connected to the wheel rotation shaft of the vehicle and may measure the mileage by multiplying a tire size and the number of rotations with each other. Alternatively, the sensor may measure the travel distance using GPS. Alternatively, the travel distance may be measured based on the speed of the vehicle. The measured values from the travel distance measurement sensor 240 are transmitted only to the trusted processor 221 and may be encrypted and transmitted to enhance security.

The display 230 comprises a display control unit 231 and a display unit 232.

The display control unit 231 can be controlled only by the trusted processor 221. The display control unit 231 cannot be accessed or manipulated from the outside. In particular, the display control unit 231 is not accessible from a general processor or other operating system located inside the vehicle.

The display unit 232 indicates the cumulative travel distance (odometer) value and is disposed in a display panel device of the vehicle. The display unit 232 may be a part of the entire display region, or may be a screen mode activated using a specific menu button. The screen mode is determined under the control of the display control unit 231.

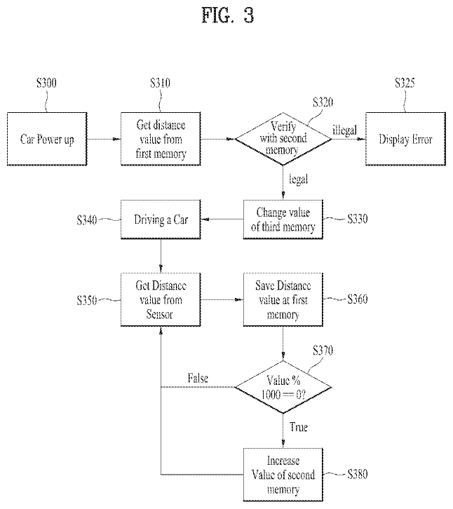

FIG. 3 shows a flow diagram of the travel distance indication method according to one embodiment of the present disclosure.

First, the user of the vehicle drives the vehicle. When the driving operation is completed, the method reads the cumulative travel distance from the first memory 211 S310. The cumulative travel distance read from the first memory 211 is verified using the cumulative travel distance encoded value in the second memory 212 S320. If the verification fails, the display 230 indicates the cumulative travel distance error S325. When the verification is completed, the cumulative travel distance is stored in the third memory 222. The vehicle starts S340. While driving the vehicle, the travel distance measurement sensor 240 acquires a measured travel distance value S350. The measured travel distance value is added to the existing cumulative travel distance, such that an updated cumulative travel distance is stored in the first memory 211 S360. After storing the updated cumulative travel distance in the first memory 211, it is checked whether it is necessary to update the cumulative travel distance encoded value in the second memory 212 S370. For example, it may be assumed that the predetermined travel distance is 1000 Km. When the value obtained by dividing the cumulative travel distance by 1000 is greater than the existing cumulative travel distance encoded value, a bit not yet used may be set to 1 in the second memory 212. If it is determined that the update is necessary, the cumulative travel distance encoded value of the second memory 212 is updated. Among the above steps, the steps S300 to S340 are performed at the initial start of the vehicle. After the vehicle starts, the steps S350 to S380 are repeatedly performed.

The method in accordance with the present disclosure as described above may be implemented using a computer readable code on a medium on which a program is recorded. The computer readable medium includes all kinds of recording devices in which data that may be read by a computer system is stored. Examples of media that can be read by a computer include HDD (Hard Disk Drive), SSD (Solid State Disk), SDD (Silicon Disk Drive), ROM, RAM, CD-ROM, magnetic tape, floppy disk, or optical data storage device. The medium also includes a carrier wave, for example, implemented in the form of transmission over the Internet. Accordingly, the above description should not be construed in a limiting sense in all respects and should be considered illustrative. The scope of the present disclosure shall be determined by rational interpretation of the appended claims. All changes within the equivalent range of the present disclosure are included in the scope of the present disclosure.

### INDUSTRIAL APPLICABILITY

The present disclosure relates to devices and methods that are installed inside a vehicle and may be used industrially.

What is claimed is:

1. A travel distance indication device including a controller, wherein the controller includes:
a storage including a first memory for storing a cumulative travel distance and a second memory for storing a cumulative travel distance encoded value;
a processing unit including a trusted processor for verifying whether the cumulative travel distance is valid, based on the cumulative travel distance encoded value; and
a display for displaying the cumulative travel distance when the cumulative travel distance is valid,
wherein the storage and the display are accessible only by the trusted processor.

2. The travel distance indication device of claim 1, wherein the first memory is a non-volatile memory, and the second memory is a memory in which data is not modified.

3. The travel distance indication device of claim 2, wherein the cumulative travel distance encoded value is a total amount of data input to the second memory and is different from the cumulative travel distance,
wherein the trusted processor further inputs data into the second memory every time a vehicle moves by a predetermined travel distance.

4. The travel distance indication device of claim 3, wherein verifying whether the cumulative travel distance is valid includes:
dividing the cumulative travel distance by the predetermined travel distance to obtain a dividing result; and
comparing the dividing result with the cumulative travel distance encoded value.

5. The travel distance indication device of claim 1, wherein the storage further comprises a third memory as a volatile memory, wherein the third memory is accessible only by the trusted processor,
wherein the third memory is used to add an measured value from a travel distance measurement sensor to the cumulative travel distance.

6. The travel distance indication device of claim 5, wherein the measured value from the travel distance measurement sensor is encrypted and transmitted to the trusted processor.

7. The travel distance indication device of claim 1, wherein the display includes a display control unit and a display unit, wherein the display control unit is accessible only by the trusted processor, wherein the display unit displays the cumulative travel distance under control of the display control unit.

8. The travel distance indication device of claim 1, wherein the processing unit further includes a general processor, wherein the general processor and the trusted processor are separate from each other, wherein the general processor performs an operation other than a travel distance related operation.

9. The travel distance indication device of claim 1, wherein the trusted processor controls the display to display an error when the cumulative travel distance is invalid.

10. A travel distance indication method comprising:
reading out a cumulative travel distance from a first memory;
reading out a cumulative travel distance encoded value from a second memory;
verifying, by a trusted processor, using the cumulative travel distance encoded value, whether the cumulative travel distance is valid; and
displaying the cumulative travel distance on a display when the cumulative travel distance is valid,
wherein the first memory is a non-volatile memory, and the second memory is a non-modifiable memory.

11. The travel distance indication method of claim 10, wherein the cumulative travel distance encoded value is a total amount of data input to the second memory and is different from the cumulative travel distance,
wherein the method further comprises inputting data into the second memory every time a vehicle moves by a predetermined travel distance.

12. The travel distance indication method of claim 11, wherein verifying whether the cumulative travel distance is valid:
dividing the cumulative travel distance by the predetermined travel distance to obtain a dividing result; and
comparing the dividing result with the cumulative travel distance encoded value.
